(19) United States
(12) Patent Application Publication
(10) Pub. No.: US 2010/0297445 A1
(43) Pub. Date: Nov. 25, 2010

(54) PRODUCTION OF SPHERICAL PARTICLES FROM SOLUTIONS COMPRISING A WATER-MISCIBLE SOLVENT BY THE METHOD OF UNDERWATER PELLETIZATION

(75) Inventors: Norbert Guentherberg, Speyer (DE); Karl-Peter Farwerck, Worms (DE); Armin Kurps, Boehl-Iggelheim (DE); Daniel Barrera-Medrano, Mannheim (DE); Eric Uerdingen, Speyer (DE); Veit Stegmann, Mannheim (DE); Michael Lutz, Speyer (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, LUDWIGSHAFEN (DE)

(21) Appl. No.: 12/744,265

(22) PCT Filed: Nov. 20, 2008
(86) PCT No.: PCT/EP2008/065904

§ 371 Date: May 21, 2010

(30) Foreign Application Priority Data
Nov. 22, 2007 (EP) 07121269.0

(51) Int. Cl. C08G 75/20; C08B 1/00; B29C 47/00

(52) U.S. Cl. 428/402; 536/56; 528/391; 264/148

(57) ABSTRACT

The present invention relates to a process for producing spherical particles of at least one material, which comprises the steps:
(A) preparation of a solution or dispersion of the at least one material in at least one water-miscible solvent or dispersion medium,
(B) conversion of the solution or dispersion obtained in step (A) into individual portions comprising an amount of the at least one material corresponding to the amount present in the spherical particles by underwater pelletization and
(C) introduction of the portions obtained in step (B) into a medium which is miscible with the solvent or dispersion medium from step (A) and in which the material used in step (A) is insoluble so that the solvent or dispersion medium used in step (A) is replaced by the medium which is miscible with the solvent or dispersion medium from step (A) and the material solidifies to form the spherical particle.

The present invention relates to a process for producing spherical particles of at least one material using underwater pelletization and spherical particles which comprise at least one material selected from the group consisting of natural polymers, synthetic polymers and mixtures thereof and have a particularly low polydispersity.

Processes for producing spherical particles of, for example, cellulose are already known from the prior art.

DE 44 24 998 A1 discloses a process and an apparatus for producing particles from a liquid medium, in which the liquid medium is introduced in portions into an environment which effects solidification and the liquid medium moves in the form of a liquid jet in the direction of the environment which effects solidification and the formation of the portions is carried out by the liquid jet being divided by periodic removal of liquid from this liquid jet before the environment which effects solidification. A disadvantage of this process is that the solution removed from the jet is no longer available to the process for forming spherical particles. Another disadvantage is that the liquid jet has to cover a distance through air or a gaseous atmosphere in order to be divided into portions.

DE 101 02 334 A1 discloses a process for producing regular, monodisperse cellulose beads, in which a cellulose solution is converted into droplets by means of a capillary, these are allowed to travel under gravity through an air gap into a liquid medium in which they assume the shape of a sphere. This sphere sinks through the liquid medium under the action of gravity and, after passing through a boundary layer, goes into a further solvent which acts as precipitate for the material comprised in the particle, so that solidification of the spherical particles occurs.

WO 02/057319 A2 discloses a process for producing regular, monodisperse cellulose beads, in which a cellulose solution is converted into droplets by means of a capillary, these are allowed to travel under gravity through an air gap into a liquid medium in which they assume the shape of a sphere and, since the liquid medium is a precipitate for the material present in the spherical particles, solidify.

EP 0 850 979 A2 discloses a process for producing cellulose beads. In this, a cellulose solution is introduced into a flask which rotates around its longitudinal axis. The centrifugal force which arises pushes the cellulose solution through holes present in the flask and the spherical cellulose solution beads formed in this way are collected in a medium which acts as a precipitate for cellulose, so that the cellulose beads solidify.

DD 147 114 discloses a process for producing cellulose spheres from cellulose xanthogenate solutions, in which a cellulose xanthogenate solution (viscose) is pressed through feed openings into a liquid which is not miscible with viscose and coagulates thermally in this liquid since the cellulose xanthogenate is converted under the action of heat energy into cellulose which is not soluble in the liquid.

Disadvantages of the processes mentioned in the prior art for producing spherical particles, for example cellulose beads, is that a large outlay in terms of apparatus is necessary to produce the corresponding spherical particles from the cellulose solution. Furthermore, the spherical particles are obtained with contamination comprising precipitate and/or solvent which have to be removed in further complicated process steps in the process of the prior art.

It is therefore an object of the present invention to provide a process for producing spherical particles which is particularly simple to carry out. Furthermore, the process of the invention should make it possible to obtain spherical particles which are not contaminated by a precipitate or a solvent other than water, so that complicated purification steps can be dispensed with. The spherical particles obtained should have a uniform size, i.e. a low polydispersity.

These objects are achieved by a process for producing spherical particles of at least one material, which comprises the steps:
a. preparation of a solution or dispersion of the at least one material in at least one water-miscible solvent or dispersion medium,
b. conversion of the solution or dispersion obtained in step (A) into individual portions comprising an amount of the at least one material corresponding to the amount present in the spherical particles by underwater pelletization and
c. introduction of the portions obtained in step (B) into a medium which is miscible with the solvent or dispersion medium from step (A) and in which the material used in step (A) is insoluble so that the solvent or dispersion medium used in step (A) replaced by the medium which is miscible with the solvent or dispersion medium from step (A) and the material solidifies to form the spherical particle.

The individual steps of the process of the invention for producing spherical particles of at least one material are described in detail below.

### Step (A):

Step (A) of the process of the invention comprises the preparation of a solution or dispersion of the at least one material in at least one water-miscible solvent or dispersion medium. In a preferred embodiment, a solution is prepared in step (A) of the process of the invention. However, corresponding solutions which are obtained in a preceding production process can also be used directly.

In general, it is possible to use all solvents or dispersion media which are miscible with water in step (A). For the purposes of the present patent application, miscible means that water and the respective solvent or dispersion medium can be mixed in any ratio to one another without a phase boundary being formed between the two solvents.

In a preferred embodiment, the at least one water-miscible solvent or dispersion medium is selected from the group consisting of cyclic ethers, for example tetrahydrofuran (THF), cyclic amides, for example N-methylpyrrolidone (NMP), sulfur-comprising organic solvents, for example dimethyl sulfoxide (DMSO), alcohols, for example methanol, ethanol, n-propanol, isopropanol, n-butanol, isobutanol, tert-butanol, ketones, for example acetone, ionic liquids and mixtures thereof.

In a particularly preferred embodiment, at least one ionic liquid is used as solvent in step (A) of the process of the invention. For the purposes of the present invention, ionic liquids are preferably salts of the general formula (I)

[A]⁺ₙ[Y]ⁿ⁻ (I)

where n is 1, 2, 3 or 4, [A]⁺ is a quaternary ammonium cation, an oxonium cation, a sulfonium cation or a phosphonium cation and [Y]ⁿ⁻ is a monovalent, divalent, trivalent or tetravalent anion, or
mixed salts of the general formulae (II)

[A¹]⁺[A²]⁺[Y]ⁿ⁻ (IIa),

where n=2,

[A¹]⁺[A²]⁺[A³]⁺[Y]ⁿ⁻ (IIb),

where n=3, or

[A¹]⁺[A²]⁺[A³]⁺[A⁴]⁺[Y]ⁿ⁻ (IIIc),

where n=4,
where [A¹]⁺, [A²]⁺[A³]⁺ and [A⁴]⁺ are selected independently from among the groups mentioned for [A]⁺ and [Y]ⁿ⁻ is as defined under (A).

Compounds suitable for forming the cation [A]⁺ of ionic liquids are, for example, known from DE 102 02 838 A1. Thus, such compounds can comprise oxygen, phosphorus, sulfur or in particular nitrogen atoms, for example at least one nitrogen atom, preferably from 1 to 10 nitrogen atoms, particularly preferably from 1 to 5, very particularly preferably from 1 to 3 and in particular 1 or 2, nitrogen atoms. If appropriate, further heteroatoms such as oxygen, sulfur or phosphorus atoms can also be comprised. The nitrogen atom is a suitable carrier of the positive charge in the cation of the ionic liquid, from which a proton or an alkyl radical can then go over in equilibrium to the anion to produce an electrically neutral molecule.

If the nitrogen atom is the carrier of the positive charge in the cation of the ionic liquid, a cation can firstly be produced by quaternization of the nitrogen atom of, for instance, an amine or nitrogen heterocycle in the synthesis of the ionic liquids. Quaternization can be effected by alkylation of the nitrogen atom. Depending on the alkylating reagent used, salts having different anions are obtained. In cases in which it is not possible to form the desired anion in the quaternization, this can be carried out in a further step of the synthesis. Starting from, for example, an ammonium halide, the halide can be reacted with a Lewis acid to form a complex anion from halide and Lewis acid. As an alternative, replacement of a halide ion by the desired anion is possible. This can be effected by addition of a metal salt with coagulation of the metal halide formed, by means of an ion exchanger or by displacement of the halide ion by a strong acid (with liberation of the hydrogen halide). Suitable processes are described, for example, in Angew. Chem. 2000, 112, pp. 3926-3945, and the references cited therein.

Suitable alkyl radicals by means of which the nitrogen atom in the amines or nitrogen heterocycles can, for example, be quaternized are C₁-C₁₈-alkyl, preferably C₁-C₁₀-alkyl, particularly preferably C₁-C₆-alkyl and very particularly preferably methyl. The alkyl group can be unsubstituted or have one or more identical or different substituents.

Preference is given to compounds comprising at least one five- or six-membered heterocycle, in particular a five-membered heterocycle, which has at least one nitrogen atom and, if appropriate, an oxygen or sulfur atom. Particular preference is likewise given to compounds comprising at least one five- or six-membered heterocycle which has one, two or three nitrogen atoms and a sulfur or oxygen atom, very particularly preferably those having two nitrogen atoms. Further preference is given to aromatic heterocycles.

Particularly preferred compounds are those which have a molecular weight of less than 1000 g/mol, very particularly preferably less than 500 g/mol and in particular less than 300 g/mol.

Furthermore, preference is given to cations selected from among the compounds of the formulae (IIIa) to (IIIw)

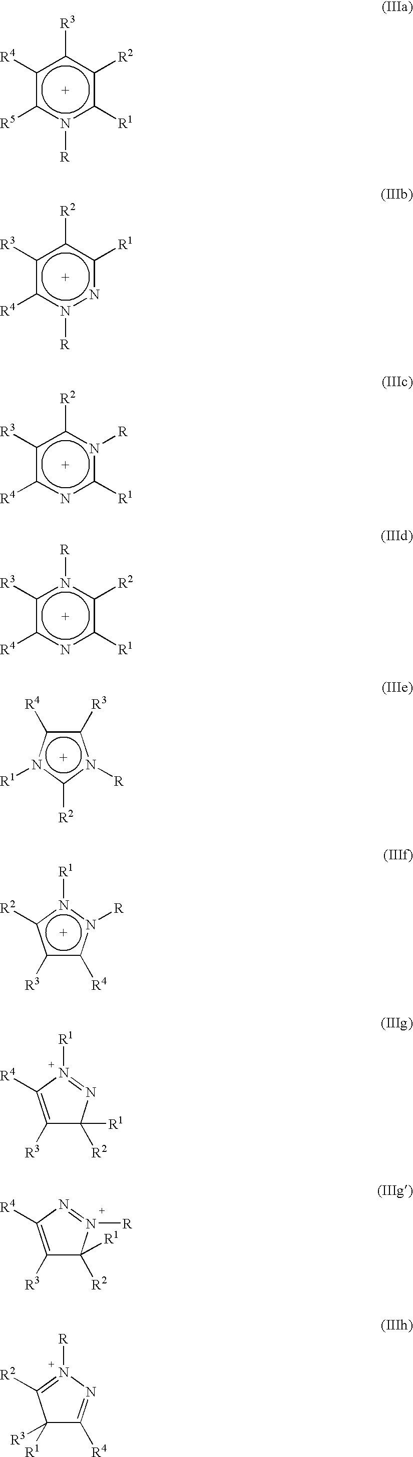

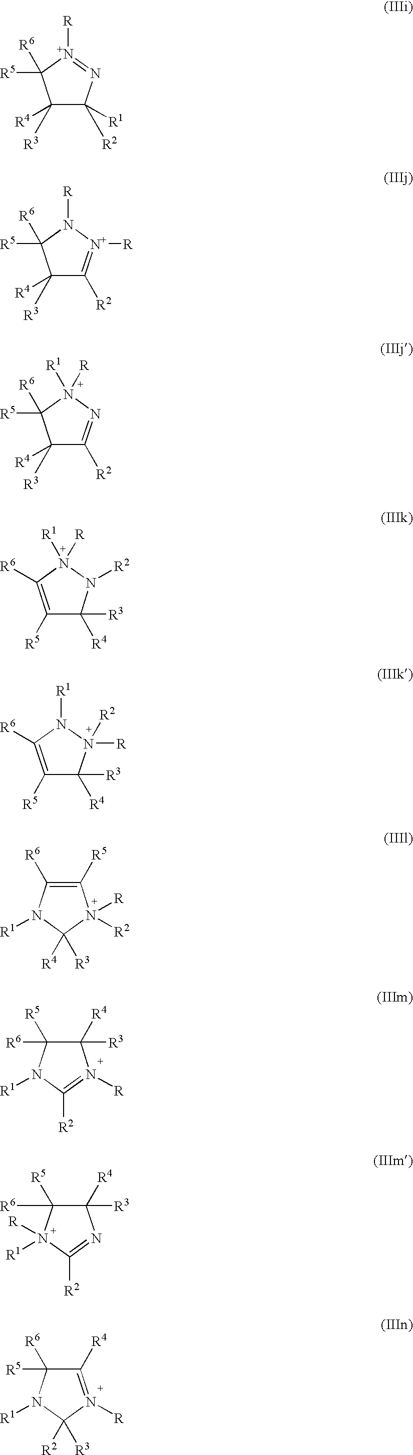

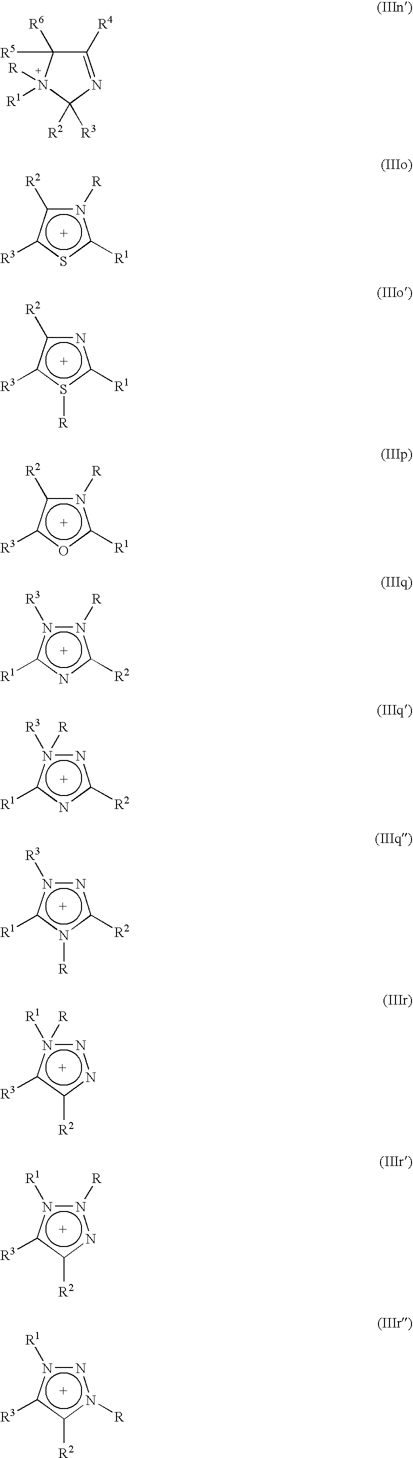

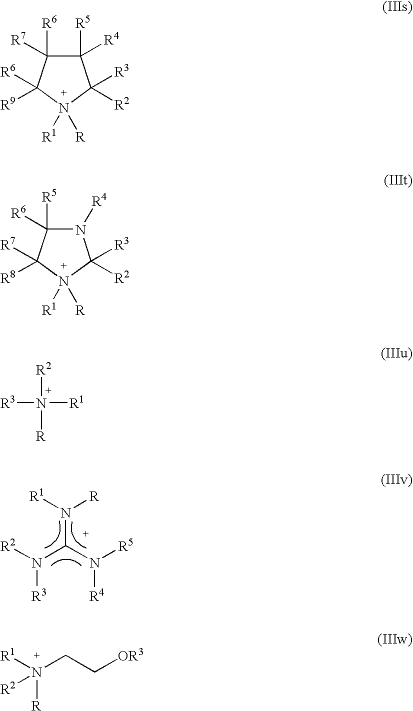

and oligomers comprising these structures.

Further suitable cations are compounds of the general formulae (IIIx) and (IIIy)

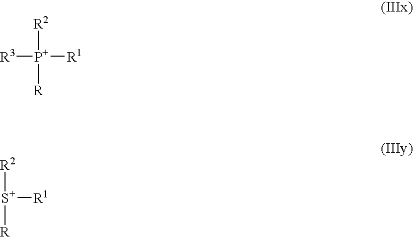

and oligomers comprising these structures.

In the abovementioned formulae (IIIa) to (IIIy),
the radical R is hydrogen, a carbon-comprising organic, saturated or unsaturated, acyclic or cyclic, aliphatic, aromatic or araliphatic radical which has from 1 to 20 carbon atoms and may be unsubstituted or interrupted or substituted by from 1 to 5 heteroatoms or functional groups and
the radicals R¹ to R⁹ are each, independently of one another, hydrogen, a sulfo group or a carbon-comprising organic, saturated or unsaturated, acyclic or cyclic, aliphatic, aromatic or araliphatic radical which has from 1 to 20 carbon atoms and may be unsubstituted or interrupted or substituted by from 1 to 5 heteroatoms or functional groups, where the radicals R¹ to R⁹ which in the abovementioned formulae (III) are bound to a carbon atom and not to a heteroatom may also be halogen or a functional group or
two adjacent radicals from among R¹ to R⁹ may together form a divalent, carbon-comprising organic, saturated or unsaturated, acyclic or cyclic, aliphatic, aromatic or araliphatic radical which has from 1 to 30 carbon atoms and may be unsubstituted or interrupted or substituted by from 1 to 5 heteroatoms or functional groups.

In the definition of the radicals R and R¹ to R⁹, possible heteroatoms are in principle all heteroatoms which are able formally to replace a —CH₂— group, a —CH═ group, a —C—C— triple bond or a ═C═ group. If the carbon-comprising radical comprises heteroatoms, preference is given to oxygen, nitrogen, sulfur, phosphorus and silicon. Preferred groups are, in particular, —O—, —S—, —SO—, —SO₂—, —NR′—, —N═, —PR′—, —PR′₂ and —SiR′₂—, where the radicals R′ are the remaining part of the carbon-comprising radical. In cases in which the radicals R¹ to R⁹ in the abovementioned formulae (III) are bound to a carbon atom and not to a heteroatom, these can also be bound directly via the heteroatom.

Possible functional groups are in principle all functional groups which can be bound to a carbon atom or a heteroatom. Examples of suitable functional groups are —OH (hydroxy), ═O (in particular as carbonyl group), —NH₂ (amino), —NHR, —NR₂, ═NH (imino), —COOH (carboxy), —CONH₂ (carboxamide), —SO₃H (sulfo) and —CN (cyano). Functional groups and heteroatoms can also be directly adjacent, so that combinations of a plurality of adjacent atoms such as —O— (ether), —S-(thioether), —COO— (ester), —CONH— (secondary amide) or —CONR′— (tertiary amide) are also comprised, for example di(C₁-C₄-alkyl)amino, C₁-C₄-alkyloxycarbonyl or C₁-C₄-alkyloxy.

As halogens, mention may be made of fluorine, chlorine, bromine and iodine.

The radical R is preferably
unbranched or branched C₁-C₁₈-alkyl which has a total of from 1 to 20 carbon atoms and may be unsubstituted or substituted by one or more hydroxy, halogen, phenyl, cyano, C₁-C₆-alkoxycarbonyl and/or SO₃H groups, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid;
glycols, butylene glycols and their oligomers having from 1 to 100 units and a hydrogen or C₁-C₈-alkyl as end group, for example R^{A}O—(CHR^{B}—CH₂—O)ₘ—CHR^{B}—CH₂— or R^{A}O—(CH₂CH₂CH₂CH₂O)ₘ—CH_{Z}CH_{Z}CH_{Z}CH_{Z}O— where R^{A} and R^{B} are each preferably hydrogen, methyl or ethyl and m is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradecyl;
vinyl, and
allyl,
N,N-di-C₁-C₆-alkylamino, for example N,N-dimethylamino and N,N-diethylamino.

The radical R is particularly preferably unbranched and unsubstituted C₁-C₁₈-alkyl, for example methyl, ethyl, allyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, in particular methyl, ethyl, 1-butyl and 1-octyl, or CH₃O—(CH₂CH₂O)ₘ—CH₂CH₂— and CH₃CH₂O—(CH₂CH₂O)ₘ—CH₂CH₂— where m is from 0 to 3.

Preference is given to the radicals R¹ to R⁹ each being, independently of one another,
hydrogen,
halogen,
a functional group,
C₁-C₁₈-alkyl which may optionally be substituted by functional groups, aryl, alkyl, aryloxy, alkyloxy, halogen, heteroatoms and/or heterocycles and/or interrupted by one or more oxygen and/or sulfur atoms and/or one or more substituted or unsubstituted imino groups,
C₂-C₁₈-alkenyl which may optionally be substituted by functional groups, aryl, alkyl, aryloxy, alkyloxy, halogen, heteroatoms and/or heterocycles and/or interrupted by one or more oxygen and/or sulfur atoms and/or one or more substituted or unsubstituted imino groups,
C₆-C₁₂-aryl which may optionally be substituted by functional groups, aryl, alkyl, aryloxy, alkyloxy, halogen, heteroatoms and/or heterocycles,
C₅-C₁₂-cycloalkyl which may optionally be substituted by functional groups, aryl, alkyl, aryloxy, alkyloxy, halogen, heteroatoms and/or heterocycles,
C₅-C₁₂-cycloalkenyl which may optionally be substituted by functional groups, aryl, alkyl, aryloxy, alkyloxy, halogen, heteroatoms and/or heterocycles or
a five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles, or
two adjacent radicals which together form an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups.

C₁-C₁₈-Alkyl which may optionally be substituted by functional groups, aryl, alkyl, aryloxy, alkyloxy, halogen, heteroatoms and/or heterocycles is preferably methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethylpentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl, cyclopentylmethyl, 2-cyclopentylethyl, 3-cyclopentylpropyl, cyclohexylmethyl, 2-cyclohexylethyl, 3-cyclohexylpropyl, benzyl (phenylmethyl), diphenylmethyl (benzhydryl), triphenylmethyl, 1-phenylethyl, 2-phenylethyl, 3-phenylpropyl, [alpha],[alpha]-dimethylbenzyl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonylpropyl, 1,2-di(methoxycarbonyl)ethyl, methoxy, ethoxy, formyl, 1,3-dioxolan-2-yl, 1,3-dioxan-2-yl, 2-methyl-1,3-dioxolan-2-yl, 4-methyl-1,3-dioxolan-2-yl, 2-hydroxyethyl, 2-hydroxypropyl, 3-hydroxypropyl, 4-hydroxybutyl, 6-hydroxyhexyl, 2-aminoethyl, 2-aminopropyl, 3-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl, 6-ethoxyhexyl, acetyl, CₘF_{2(m-a)+(1-b)}H_{2a+b} where m is from 1 to 30, 0≦a≦m and b=0 or 1 (for example CF₃, C₂F₅, CH₂CH₂—C₍ₘ₋₎F2_{(m-z)+1}, C₆F₁₃, C₈F₁₇, C₁₀F₂₁, C₁₂F₂₅), chloromethyl, 2-chloroethyl, trichloromethyl, 1,1-dimethyl-2-chloroethyl, methoxymethyl, 2-butoxyethyl, diethoxymethyl, diethoxyethyl, 2-isopropoxyethyl, 2-butoxypropyl, 2-octyloxyethyl, 2-methoxyisopropyl, 2-(methoxycarbonyl)ethyl, 2-(ethoxycarbonyl)ethyl, 2-(n-butoxycarbonyl)ethyl, butylthiomethyl, 2-dodecylthioethyl, 2-phenylthioethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-dioxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-dioxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

C₂-C₁₈-Alkenyl which may optionally be substituted by functional groups, aryl, alkyl, aryloxy, alkyloxy, halogen, heteroatoms and/or heterocycles and/or interrupted by one or more oxygen and/or sulfur atoms and/or one or more substituted or unsubstituted imino groups is preferably vinyl, 2-propenyl, 3-butenyl, cis-2-butenyl, trans-2-butenyl or CₘF_{2(m-a)-(1-b)}H_{2a-b} where m≦30, 0≦a≦m and b=0 or 1.

C₆-C₁₂-Aryl which may optionally be substituted by functional groups, aryl, alkyl, aryloxy, alkyloxy, halogen, heteroatoms and/or heterocycles is preferably phenyl, tolyl, xylyl, [alpha]-naphthyl, [beta]-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl or tertbutylthiophenyl or C₆F₍₅₋ₐ₎Hₐ where 0≦a≦5.

C₅-C₁₂-Cycloalkyl which may optionally be substituted by functional groups, aryl, alkyl, aryloxy, alkyloxy, halogen, heteroatoms and/or heterocycles is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl, CₘF_{2(m-a)-(1-b)}H_{2a-b} where m≦30, 0≦a≦m and b=0 or 1 or a saturated or unsaturated bicyclic system such as norbornyl or norbornenyl.

C₅-C₁₂-Cycloalkenyl which may optionally be substituted by functional groups, aryl, alkyl, aryloxy, alkyloxy, halogen, heteroatoms and/or heterocycles is preferably 3-cyclopentenyl, 2-cyclohexenyl, 3-cyclohexenyl, 2,5-cyclohexadienyl or CₙF_{2(m-a)-3(1-b)}H_{2a-3b} where m≦30, 0≦a≦m and b=0 or 1.

A five- or six-membered, oxygen-, nitrogen- and/or sulfur-comprising heterocycle which may optionally be substituted by functional groups, aryl, alkyl, aryloxy, alkyloxy, halogen, heteroatoms and/or heterocycles is preferably furyl, thiophenyl, pyrryl, pyridyl, indolyl, benzoxazolyl, dioxolyl, dioxyl, benzimidazolyl, benzthiazolyl, dimethylpyridyl, methylquinolyl, dimethylpyrryl, methoxyfuryl, dimethoxypyridyl or difluoropyridyl.

If two adjacent radicals together form an unsaturated, saturated or aromatic ring which may optionally be substituted by functional groups, aryl, alkyl, aryloxy, alkyloxy, halogen, heteroatoms and/or heterocycles and may optionally be interrupted by one or more oxygen and/or sulfur atoms and/or one or more substituted or unsubstituted imino groups, the two radicals together are preferably 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

If the abovementioned radicals comprise oxygen and/or sulfur atoms and/or substituted or unsubstituted imino groups, the number of oxygen and/or sulfur atoms and/or imino groups is not subject to any restrictions. There will generally be no more than 5 in the radical, preferably no more than 4 and very particularly preferably no more than 3.

If the abovementioned radicals comprise heteroatoms, there will generally be at least one carbon atom, preferably at least two carbon atoms, between each two heteroatoms.

Particular preference is given to the radicals R¹ to R⁹ each being, independently of one another,
hydrogen,
unbranched or branched C₁-C₁₈-alkyl which has a total of from 1 to 20 carbon atoms and is unsubstituted or substituted by one or more hydroxy, halogen, phenyl, cyano, C₁-C₆-alkoxycarbonyl and/or SO₃H groups, for example methyl, ethyl, 1-propyl, 2-propyl, 1-butyl, 2-butyl, 2-methyl-1-propyl, 2-methyl-2-propyl, 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, 2-(methoxycarbonyl)ethyl, 2-(ethoxycarbonyl)ethyl, 2-(nbutoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and propylsulfonic acid,
glycols, butylene glycols and their oligomers having from 1 to 100 units and a hydrogen or C₁-C₈-alkyl as end group, for example R^{A}O—(CHR^{B}—CH₂—O)ₘ—CHR^{B}CH₂— or R^{A}O—(CH₂CH₂CH₂CH₂O)ₘ—CH₂CH₂CH₂CH₂O— where R^{A} and R^{B} are each preferably hydrogen, methyl or ethyl and n is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxamidecyl and 3,6,9,12-tetraoxatetradetyl,
vinyl, and
allyl
N,N-di-C₁-C₆-alkylamino, for example N,N-dimethylamino and N,N-diethylamino.

Very particular preference is given to the radicals R¹ to R⁹ each being, independently of one another, hydrogen or C₁-C₁₈-alkyl, for example methyl, ethyl, 1-butyl, 1-pentyl, 1-hexyl, 1-heptyl, 1-octyl, phenyl, 2-hydroxyethyl, 2-cyanoethyl, 2-(methoxycarbonyl)ethyl, 2-(ethoxycarbonyl)ethyl, 2-(n-butoxycarbonyl)ethyl, N,N-dimethylamino, N,N-diethylamino, chlorine or CH₃O—(CH₂CH₂O)ₘ—CH₂CH₂— or CH₃CH₂O—(CH₂CH₂O)ₘ—CH₂CH₂— where m is from 0 to 3.

Very particularly preferred pyridinium ions (IIIa) are those in which
one of the radicals R¹ to R⁵ is methyl, ethyl or chlorine and the remaining radicals R′ to R⁵ are each hydrogen,
R³ is dimethylamino and the remaining radicals R¹, R², R⁴ and R⁵ are each hydrogen,
all radicals R¹ to R⁵ are hydrogen,
R² is carboxy or carboxamide and the remaining radicals R′, R², R⁴ and R⁵ are each hydrogen or
R¹ and R² or R² and R³ are together 1,4-buta-1,3-dienylene and the remaining radicals R¹, R², R⁴ and R⁵ are each hydrogen,
   and in particular those in which
R¹ to R⁵ are each hydrogen or
one of the radicals R¹ to R⁵ is methyl or ethyl and the remaining radicals R¹ to R⁵ are each hydrogen.

As very particularly preferred pyridinium ions (IIIa), mention may be made of 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethylpyridinium, 1-(1-dodecyl)-2-methyl-3-ethylpyridinium, 1-(1-tetradecyl)-2-methyl-3-ethylpyridinium and 1-(1-hexadecyl)-2-methyl-3-ethylpyridinium.

Very particularly preferred pyridazinium ions (IIIb) are those in which
R¹ to R⁴ are each hydrogen or
one of the radicals R¹ to R⁴ is methyl or ethyl and the remaining radicals R¹ to R⁴ are each hydrogen.

Very particularly preferred pyrimidinium ions (IIIc) are those in which
R¹ is hydrogen, methyl or ethyl and R² to R⁴ are each, independently of one another, hydrogen or methyl or
R¹ is hydrogen, methyl or ethyl, R² and R⁴ are each methyl and R³ is hydrogen.

Very particularly preferred pyrazinium ions (IIId) are those in which
R¹ is hydrogen, methyl or ethyl and R² to R⁴ are each, independently of one another hydrogen or methyl,
R¹ is hydrogen, methyl or ethyl, R² and R⁴ are each methyl and R³ is hydrogen,
R¹ to R⁴ are each methyl or
R¹ to R⁴ are each methyl or hydrogen.

Very particularly preferred imidazolium ions (Ille) are those in which
R¹ is hydrogen, methyl, ethyl, 1-propyl, 1-butyl, 1-pentyl, 1-hexyl, 1-octyl, allyl, 2-hydroxyethyl or 2-cyanoethyl and R² to R⁴ are each, independently of one another, hydrogen, methyl or ethyl.

As very particularly preferred imidazolium ions (Ille), mention may be made of 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butylimidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazofium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium and 1,4,5-trimethyl-3-octylimidazolium.

Very particularly preferred pyrazolium ions (IIIf), (IIIg) and (IIIg′) are those in which —R¹ is hydrogen, methyl or ethyl and R² to R⁴ are each, independently of one another, hydrogen or methyl.

Very particularly preferred pyrazolium ions (IIIh) are those in which
R¹ to R⁴ are each, independently of one another, hydrogen or methyl.

Very particularly preferred 1-pyrazolinium ions (IIIi) are those in which
R¹ to R⁶ are each, independently of one another, hydrogen or methyl.

Very particularly preferred 2-pyrazolinium ions (IIIj) and MID are those in which
R¹ is hydrogen, methyl, ethyl or phenyl and R² to R⁶ are each, independently of one another, hydrogen or methyl.

Very particularly preferred 3-pyrazolinium ions (IIIk) and (IIIk′) are those in which
R¹ and R² are each, independently of one another, hydrogen, methyl, ethyl or phenyl and R³ to R⁶ are each, independently of one another, hydrogen or methyl.

Very particularly preferred imidazolinium ions (IIII) are those in which
R¹ and R² are each, independently of one another, hydrogen, methyl, ethyl, 1-butyl or phenyl, R³ and R⁴ are each, independently of one another, hydrogen, methyl or ethyl and R⁵ and R⁶ are each, independently of one another, hydrogen or methyl.

Very particularly preferred imidazolinium ions (IIIm) and (IIIm′) are those in which
R¹ and R² are each, independently of one another, hydrogen, methyl or ethyl and R³ to R⁶ are each, independently of one another, hydrogen or methyl.

Very particularly preferred imidazolinium ions (IIIn) and (IIIn′) are those in which
R¹ to R³ are each, independently of one another, hydrogen, methyl or ethyl and R⁴ to R⁶ are each, independently of one another, hydrogen or methyl.

Very particularly preferred thiazolium ions (IIIo) and (IIIo′) and oxazolium ions (IIIp) are those in which
R¹ is hydrogen, methyl, ethyl or phenyl and R² and R³ are each, independently of one another, hydrogen or methyl.

Very particularly preferred 1,2,4-triazolium ions (IIIq), (IIIq′) and (IIIq″) are those in which
R¹ and R² are each, independently of one another, hydrogen, methyl, ethyl or phenyl and R³ is hydrogen, methyl or phenyl.

Very particularly preferred 1,2,3-triazolium ions (IIIr), (IIIr′) and (IIIr″) are those in which
R¹ is hydrogen, methyl or ethyl and R² and R³ are each, independently of one another, hydrogen or methyl or R² and R³ together are 1,4-buta-1,3-dienylene.

Very particularly preferred pyrrolidinium ions (IIIs) are those in which
R¹ is hydrogen, methyl, ethyl or phenyl and R² to R⁹ are each, independently of one another, hydrogen or methyl.

Very particularly preferred imidazolidinium ions (IIIt) are those in which
R¹ and R⁴ are each, independently of one another, hydrogen, methyl, ethyl or phenyl and R² and R³ and also R⁵ to R⁸ are each, independently of one another, hydrogen or methyl.

Very particularly preferred ammonium ions (IIIu) are those in which
R¹ to R³ are each, independently of one another, C₁-C₁₈-alkyl or
R¹ and R² together are 1,5-pentylene or 3-oxa-1,5-pentylene and R³ is C₁-C₁₈-alkyl, 2-hydroxyethyl or 2-cyanoethyl.

As very particularly preferred ammonium ions (IIIu), mention may be made of methyltri(1-butyl)ammonium, N,N-dimethylpiperidinium and N,N-dimethylmorpholinium.

Examples of tertiary amines from which the quaternary ammonium ions of the general formula (IIIu) are derived by quaternization with the abovementioned radicals R are diethyl-n-butylamine, diethyl-tert-butylamine, diethyl-n-pentylamine, diethylhexylamine, diethyloctylamine, diethyl(2-ethylhexyl)amine, di-n-propylbutylamine, di-n-propyl-n-pentylamine, di-n-propylhexylamine, di-n-propyloctylamine, di-n-propyl(2-ethylhexyl)amine, diisopropylethylamine, diisopropyl-n-propylamine, diisopropylbutylamine, diisopropylpentylamine, diisopropylhexylamine, diisopropyloctylamine, diisopropyl(2-ethylhexyl)amine, di-n-butylethylamine, di-n-butyl-n-propylamine, di-n-butyln-pentylamine, di-n-butylhexylamine, di-n-butyloctylamine, di-n-butyl(2-ethylhexyl)amine, N-n-butylpyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentylmorpholine, N-benzylN-ethylaniline, N-benzyl-N-n-propylaniline, N-benzyl-N-isopropylaniline, N-benzylN-n-butylaniline, N,N-dimethyl-p-toluidine, N,N-diethyl-p-toluidine, N,N-di-n-butylp-toluidine, diethylbenzylamine, di-n-propylbenzylamine, di-n-butylbenzylamine, diethylphenylamine, di-n-propylphenylamine and di-n-butylphenylamine.

Preferred tertiary amines are diisopropylethylamine, diethyl-tert-butylamine, diisopropylbutylamine, di-n-butyl-n-pentylamine, N,N-di-n-butylcyclohexylamine and tertiary amines derived from pentylisomers.

Very particularly preferred tertiary amines are di-n-butyl-n-pentylamine and tertiary amines derived from pentylisomers. A further preferred tertiary amine which has three identical radicals is triallylamine.

Very particularly preferred guanidinium ions (IIIv) are those in which
R¹ to R⁵ are each methyl.

A very particularly preferred guanidinium ion (IIIv) is N,N,N′,N′,N″,N″-hexamethylguanidinium.

Very particularly preferred cholinium ions (IIIw) are those in which
R¹ and R² are each, independently of one another, methyl, ethyl, 1-butyl or 1-octyl and R³ is hydrogen, methyl, ethyl, acetyl, —SO₂OH or —PO(OH)₂,
R¹ is methyl, ethyl, 1-butyl or 1-octyl, R² is a —CH₂—CH₂—OR⁴— group and R³ and R⁴ are each, independently of one another, hydrogen, methyl, ethyl, acetyl, —SO₂OH or —PO(OH)₂ or
R¹ is a —CN₂—CH₂—OR⁴— group, R² is a —CH₂—CH₂—OR⁵— group and R³ to R⁵ are each, independently of one another, hydrogen, methyl, ethyl, acetyl, —SO₂OH or —PO(OH)₂.

Particular preference is given to cholinium ions (IIIw) in which R³ is selected from among hydrogen, methyl, ethyl, acetyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

As very particularly preferred cholinium ions (IIIw), mention may be made of trimethyl-2-hydroxyethylammonium, dimethylbis-2-hydroxyethylammonium or methyltris-2-hydroxyethylammonium.

Very particularly preferred phosphonium ions (IIIx) are those in which
R¹ to R³ are each, independently of one another, C₁-C₁₈-alkyl, in particular butyl, isobutyl, 1-hexyl or 1-octyl.

Among the abovementioned heterocyclic cations, preference is given to the pyridinium ions, pyrazolinium ions, pyrazolium ions and the imidazolinium and imidazolium ions. Ammonium and cholinium ions are also preferred.

Particular preference is given to 1-methylpyridinium, 1-ethylpyridinium, 1-(1-butyl)pyridinium, 1-(1-hexyl)pyridinium, 1-(1-octyl)pyridinium, 1-(1-hexyl)pyridinium, 1-(1-octyl)pyridinium, 1-(1-dodecyl)pyridinium, 1-(1-tetradecyl)pyridinium, 1-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methylpyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 1-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium, 1-(1-octyl)-2-methyl-3-ethylpyridinium, 1-(1-dodecyl)-2-methyl-3-ethylpyridinium, 1-(1-tetradecyl)-2-methyl-3-ethylpyridinium, 1-(1-hexadecyl)-2-methyl-3-ethylpyridinium, 1-methylimidazolium, 1-ethylimidazolium, 1-(1-butyl)imidazolium, 1-(1-octyl)imidazolium, 1-(1-dodecyl)imidazolium, 1-(1-tetradecyl)imidazolium, 1-(1-hexadecyl)imidazolium, 1,3-dimethylimidazolium, 1-ethyl-3-methylimidazolium, 1-(1-butyl)-3-methylimidazolium, 1-(1-hexyl)-3-methylimidazolium, 1-(1-octyl)-3-methylimidazolium, 1-(1-dodecyl)-3-methylimidazolium, 1-(1-tetradecyl)-3-methylimidazolium, 1-(1-hexadecyl)-3-methylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium and 1-(1-octyl)-2,3-dimethylimidazolium, 1,4-dimethylimidazolium, 1,3,4-trimethylimidazolium, 1,4-dimethyl-3-ethylimidazolium, 3-butylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium, trimethyl-2-hydroxyethylammonium, dimethylbis-2-hydroxyethylammonium and methyltris-2-hydroxyethylammonium.

As anions, it is in principle possible to use all anions.

The anion [Y]ⁿ⁻ of the ionic liquid is, for example, selected from
the group of halides and halogen-comprising compounds of the formulae F⁻, Cl⁻, Br⁻, I⁻, BF₄⁻, PF₆⁻, CF₃SO₃⁻, (CF₃SO₃)₂N⁻, CF₃CO₂⁻, CCl₃CO₂⁻, CN⁻, SCN⁻, OCN⁻
the group of sulfates, sulfites and sulfonates of the general formulae SO₄⁻, HSO₄⁻, SO₃²⁻, HSO₃⁻, R^{a}OSO₃⁻, RaSO₃⁻
the group of phosphates of the general formulae PO₄³⁻, HPO₄²⁻, H₂PO₄⁻, R^{a}PO₄²⁻, HR^{a}PO₄⁻, R^{a}R^{b}PO₄⁻
the group of phosphonates and phosphinates of the general formulae R^{a}HPO₃⁻, R^{a}R^{b}PO₂⁻, R^{a}R^{b}PO₃⁻
the group of phosphites of the general formulae PO₃³⁻, HPO₃²⁻, H₂PO₃⁻, R^{a}PO₃², R^{a}HPO₃⁻, R^{a}R^{b}PO₃⁻
the group of phosphonites and phosphinites of the general formulae R^{a}R^{b}PO₂⁻, R^{a}HPO₂⁻ R^{a}R^{b}PO⁻, R^{a}HPO⁻
the group of carboxylic acids of the general formula RaCOO⁻
the group of borates of the general formulae BO₃³⁻, HBO₃²⁻, H₂BO₃⁻, R^{a}R^{b}BO₃⁻, R^{a}HBO₃⁻, R^{a}BO₃²⁻, B(OR^{a})(OR^{b})(OR^{c})(OR^{d})⁻,B(HSO₄)⁻, B(R^{a}SO4)
the group of boronates of the general formulae R^{a}BO₂², R^{a}R^{b}BO⁻
the group of silicates and silicic esters of the general formulae SiO₄⁴, HSiO₄³, H₂SiO₄²⁻, H₃SiO₄⁻, R^{a}SiO₄³⁻, R^{a}R^{b}SiO₄²⁻, R^{a}R^{b}R^{c}SiO₄⁻, HR^{a}SiO₄²⁻, H₂R^{a}SiO₄⁻, HR^{a}R^{b}SiO₄⁻
the group of alkylsilane and arylsilane salts of the general formulae R^{a}SiO₃³⁻, R^{a}R^{b}SiO₂²⁻, R^{a}R^{b}R^{c}SiO⁻, R^{a}R^{b}R^{c}SiO₃⁻, R^{a}R^{b}R^{c}SiO₂⁻, R^{a}R^{b}SiO₃²⁻
the group of carboximides, bis(sulfonyl)imides and sulfonylimides of the general formulae

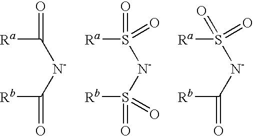

the group of methides of the general formula

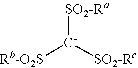

Here, R^{a}, R^{b}, R^{c} and R^{d} are each, independently of one another, hydrogen, C₁-C₃₀-alkyl, C₂-C₁₈-alkyl which may optionally be interrupted by one or more nonadjacent oxygen and/or sulfur atoms and/or one or more substituted or unsubstituted imino groups, C₆-C₁₄-aryl, C₅-C₁₂-cycloalkyl or a five- or six-membered, oxygen-, nitrogenand/or sulfur-comprising heterocycle, where two of the radicals may together form an unsaturated, saturated or aromatic ring which may optionally be interrupted by one or more oxygen and/or sulfur atoms and/or one or more unsubstituted or substituted imino groups and the radicals mentioned may in each case also be substituted by functional groups, aryl, alkyl, aryloxy, alkyloxy, halogen, heteroatoms and/or heterocycles.

Here, C₁-C₁₈-alkyl which may optionally be substituted by functional groups, aryl, alkyl, aryloxy, alkyloxy, halogen, heteroatoms and/or heterocycles are, for example, methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, heptadecyl, octadecyl, 1,1-dimethylpropyl, 1,1-dimethylbutyl, 1,1,3,3-tetramethylbutyl, benzyl, 1-phenylethyl, [alpha],[alpha]-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonethyl, 2-ethoxycarbonylethyl, 2-butoxycarbonylpropyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, trifluoromethyl, 1,1-dimethyl-2-chloroethyl, 2-methoxyisopropyl, 2-ethoxyethyl, butylthiomethyl, 2-dodecylthioethyl, 2-phenylythioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

C₂-C₁₈-Alkyl which may optionally be interrupted by one or more nonadjacent oxygen and/or sulfur atoms and/or one or more substituted or unsubstituted imino groups is, for example, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals form a ring, these radicals together can be, for example as fused-on building block, 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The number of nonadjacent oxygen and/or sulfur atoms and/or imino groups is not restricted in principle or is restricted automatically by the size of the radical or the ring building block. In general, there will be no more than 5 in the respective radical, preferably no more than 4 and very particularly preferably no more than 3. Furthermore, there is generally at least one carbon atom, preferably at least two carbon atoms, between each two heteroatoms.

Substituted and unsubstituted imino groups can be, for example, imino, methylimino, isopropylimino, n-butylimino or tert-butylimino.

The term “functional groups” refers, for example, to the following: carboxy, carboxamide, hydroxy, di(C₁-C₄-alkyl)amino, C₁-C₄-alkyloxycarbonyl, cyano or C₁-C₄-alkoxy. Here, C₁-C₄-alkyl is methyl, ethyl, propyl, isopropyl, n-butyl, sec-butyl or tert-butyl.

C₆-C₁₄-Aryl which may optionally be substituted by functional groups, aryl, alkyl, aryloxy, alkyloxy, halogen, heteroatoms and/or heterocycles is, for example, phenyl, tolyl, xylyl, [alpha]-naphthyl, [beta]-naphthyl, 4-diphenylyl, chlorophenyl, dichlorophenyl, trichlorophenyl, difluorophenyl, methylphenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethylphenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

C₅-C₁₂-Cycloalkyl which may optionally be substituted by functional groups, aryl, alkyl, aryloxy, halogen, heteroatoms and/or heterocycles is, for example, cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

A five- or six-membered, oxygen-, nitrogen- and/or sulfur-comprising heterocycle is, for example, furyl, thiophenyl, pyryl, pyridyl, indolyl, benzoxazolyl, dioxolyl, dioxyl, benzimidazolyl, benzthiazolyl, dimethylpyridyl, methylquinolyl, dimethylpyryl, methoxyfuryl, dimethoxypyridyl, difluoropyridyl, methylthiophenyl, isopropylthiophenyl or tertbutylthiophenyl.

It goes without saying that it can also be advantageous to use a specific mixture of various ionic liquids from among those described above in a particular case. In the context of the invention, it has been found that ionic liquids having an imidazolium cation in the salt concerned are particularly advantageous. Here, very particular preference is given to the 1 and 3 positions or the 1, 2 and 3 positions of the imidazolium ring being substituted by a (C₁-C₆)-alkyl group. It has been found to be particularly advantageous for the imidazolium cation to be a 1-ethyl-3-methylimidazolium, 1,3-dimethylimidazolium or 1-butyl-3-methylimidazolium cation.

The ionic liquids are also not significantly restricted in respect of the choice of the anion to balance the abovementioned cations. Particular preference is given to the anion balancing the respective cation being a halide, perchlorate, pseudohalide, sulfate, in particular hydrogensulfate, sulfilte, sulfonate, phosphate, alkylphosphate, in particular monoalkylphosphate and/or dialkylphosphate, anion (preferred alkyl group: methyl, ethyl or propyl) and/or a carboxylate anion, in particular a C₁-C₆-carboxylate anion (preferably acetate or propionate anion). Particular preference is given to the halide ion being present as chloride, bromide and/or iodide ion, the pseudohalide ion being present as cyanide, thiocyanate, cyanide and/or cyanate ion and the C₁-C₆-carboxylate ion being present as formate, acetate, propionate, butyrate, hexanoate, maleate, fumarate, oxalate, lactate, pyruvate, methanesulfonate, tosylate and/or alkanesulfate ion.

To provide an ordered picture, the following advantageous anions should be indicated: R^{a}—COO⁻, R^{a}SO⁻₃, R^{a}R^{b}PO₄⁻ (where R^{a} and R^{b} are as defined above), including, in particular, the anions of the formulae (CH₃O)₂PO₂⁻ and (C₂H₅O)₂PO₂⁻ and also the benzoate anion.

In a very particularly preferred embodiment, the at least one ionic liquid is selected from the group consisting of 1-ethyl-3-imidazolium acetate, ethylmethylimidazolium chloride and mixtures thereof.

The solution or dispersion prepared in step (A) of the process of the invention generally has a concentration of the at least one material of from 1 to 35% by weight, preferably from 5 to 20% by weight.

The solution or dispersion can be prepared by all methods known to those skilled in the art, for example by placing the appropriate solvent or dispersion medium in a vessel and adding the at least one material, or vice versa. Step (A) of the process of the invention can be carried out at any suitable temperature as long as it is ensured that the solvent or dispersion medium is present in liquid form. Suitable temperatures are, for example, in the range from 0° C. to 150° C., preferably from 10° C. to 120° C. Step (A) of the process of the invention can also be carried out at any suitable pressure as long as it is ensured that the solvent is present in liquid form at this pressure. Suitable pressures are, for example, in the range from 0.1 to 100 bar.

The at least one material which is dissolved or dispersed in step (A) of the process of the invention is, in a preferred embodiment, selected from among natural polymers, synthetic polymers and mixtures thereof.

Examples of natural polymers are carbohydrates, for example starch, cellulose, sugar and derivatives thereof. Preference is given to these derivatives being in the form of esters or ethers. The esters can be, for example, cellulose acetate and cellulose butyrate and ethers can be carboxymethylcellulose, hydroxyethylcellulose and hydroxypropylcellulose.

In a particularly preferred embodiment of the process of the invention, cellulose is dissolved or dispersed in step (A). The cellulose which is preferably used has an average degree of polymerization of from about 200 to 3500, in particular from about 300 to 1500.

Examples of synthetic polymers are homopolymers or copolymers prepared from ethylenically unsaturated monomers by polyaddition or bifunctional monomers by polycondensation.

Preferred synthetic polymers are selected from the group consisting of polysulfones, polyether sulfones, polyvinyl acetate, polyphenylene ether, polyether ether ketone (PEEK) and mixtures thereof.

Particular preference is given to preparing a solution of at least one polysulfone and/or polyether sulfone in N-methylpyrrolidone or of cellulose in an ionic liquid, very particularly preferably in 1-ethyl-3-imidazolium acetate, in step (A) of the process of the invention. In a particularly preferred embodiment of the process of the invention, the at least one material is therefore cellulose and the at least one solvent or dispersion medium is an ionic liquid.

### Step (B):

Step (B) of the process of the invention comprises conversion of the solution or dispersion obtained in step (A) into individual portions comprising an amount of the at least one material which corresponds to the amount present in the spherical particle by underwater pelletization.

The process of underwater pelletization is known to those skilled in the art and is described, for example, in the product literature of the manufacturers of suitable apparatuses, for example GALA (Xanten) or BKG (www.bkg.de), also in a review article in VDI—Aufbereitungstechnik, conference proceedings 2003, ISBN 3-18-234258-4, pages 277 ff and VDI—Aufbereitungstechnik, conference proceedings 2005, ISBN 3-18-234269-X, VDI Verlag 2005, pages 285 ff. Underwater pelletization is also described in DE 103 10 829 A1.

In a preferred embodiment, the underwater pelletization is carried out by pushing the solution or dispersion obtained in step (A) through a suitable device which has openings, for example a die plate, and dividing the exiting solution or dispersion into appropriate portions on the opposite side of the device. In a preferred embodiment, the portions obtained in this way comprise an amount of the at least one material which corresponds to the amount present in the spherical particle to be produced.

In order to divide the solution or dispersion exiting through the preferred die plate into appropriate portions, it is possible to use all mechanical devices known to those skilled in the art. In a preferred embodiment, a knife is used which slides across the device having openings in order to divide the solution or dispersion exiting from the die plate into portions. In a further preferred embodiment, the knife periodically slides past the die plate so that the portions obtained comprise a uniform amount of the solution or dispersion prepared in step (A) comprising the at least one material. In a particularly preferred embodiment, a knife is used which slides across the die plate periodically.

The die plate is, in a preferred embodiment, ground flat, if appropriate polished and provided with a particular number of holes, for example from 1 to 2000 holes, for example 1, 3, 4, 8, 12, 50 or 1440 holes, which have a particular diameter, for example from 0.1 to 10 mm, preferably from 0.3 to 7 mm, particularly preferably from 0.5 to 5 mm. The holes can be arranged in concentric circles, in single rows or in nests having in each case from 3 to 12 or more holes. The flow to the die plate is preferably from the side opposite the coolant or precipitant, with the solution or dispersion comprising the polymer being transported forcibly, for example by means of a gear pump, spindle pump, screw pump or extruder.

The die plate is generally heated and the solution or dispersion is supplied to the individual holes via heated channels, either individually to each hole or as a combined stream from larger channels branching out to each hole of a nest.

The solution or dispersion exiting through these holes in the die on the side facing the fluid is preferably cut off by means of a rotating system of knives, i.e. divided into portions. The size of the portions and thus that of the particle formed therefrom is determined by the amount of solution passing through the hole per unit time and the period of time elapsing between two cuts of the rotating knives. Knives having from 2 to 20 blades, preferably from 2 to 12 blades, which are arranged in the form of a star on an axis, see also DE 103 10 829, are used. To ensure a clean cut, the rotating star of knives is pressed against the smooth plate comprising the holes, for example by means of springs. The knives are preferably very robust and cut across the holes at an angle of preferably from 10 to 90°, particularly preferably from 15 to 90°, very particularly preferably from 20 to 90°, to the perforated plate. The usual speeds of rotation of the rotating stars of knives are from 100 to 10 000 revolutions per minute (rpm), preferably from 500 to 8000 rpm, particularly preferably from 1000 to 5000 rpm. The cutting frequency for each hole can be calculated therefrom by a person skilled in the art.

The size of the portions divided off can be set by means of the rate at which the solution or dispersion is pushed through the die plate and the frequency with which the knife slides periodically across the rear side of the die plate. Thus, it is readily possible in the process of the invention to set the size of the spherical particles to be produced, for example by altering the pressure under which the solution or dispersion is pushed through the die plate or by altering the frequency with which the knife slides across the die plate. Furthermore, the size of the portions can be adjusted via the diameter of the holes in the die plate.

In a preferred embodiment, the solution or dispersion is pushed through the die plate at a pressure of from 1 to 60 bar, particularly preferably from 2 to 40 bar, in step (B) of the process of the invention.

In a further preferred embodiment of the present invention, water or a medium which is miscible with the solvent or dispersion medium from step (A) and in which the material used in step (A) is insoluble is present on the rear side of the die plate on which the solution or dispersion exits and is divided into appropriate portions, so that in this preferred embodiment the portions of the solution or dispersion which have been divided after exiting from the die plate are transferred immediately after step (B) to step (C) of the process of the invention.

### Step (C):

Step (C) comprises introduction of the portions obtained in step (B) into a medium which is miscible with the solvent or dispersion medium from step (A) and in which the material used in step (A) is insoluble, so that the solvent or dispersion medium used in step (A) is replaced by the medium and the material solidifies to form the spherical particles. For the purposes of the present invention, the term medium refers to a liquid medium.

Suitable media which are miscible with the solvent or dispersion medium from step (A) are, for example, selected from the group consisting of water, alcohols, acetone and mixtures thereof. The medium which is miscible with the solvent or dispersion medium from step (A) is particularly preferably water.

In a preferred embodiment, the portions obtained in step (B) of the process of the invention are introduced directly into step (C), i.e. the portions obtained in step (B) are not isolated beforehand.

Owing to the surface tension of the portions of solution or dispersion obtained in step (B), uniform spheres are generally formed in the medium which is miscible with the solvent or dispersion medium from step (A). Thus, spherical bodies which comprise the solution or dispersion prepared in step (A) of the at least one material in at least one water-miscible solvent or dispersion medium are obtained in step (C). As a result of the medium used in step (C) being miscible with the solvent or dispersion medium used in step (A), migration of the solvent or dispersion medium used in step (A) from the spherical particles into the medium used in step (C) which is miscible with the solvent or dispersion medium from step (A) takes place as a result of the concentration difference. At the same time, migration of the medium which is miscible with the solvent or dispersion medium from step (A) into the spherical particles takes place. Since the material used in step (A) is not soluble in this medium, preferably water, this material solidifies to form the spherical particle.

This solidification can, depending on the speed of exchange of the solvents, occur very quickly or slowly. The solidification rate thus generally depends on the material system and the particle size. It is therefore possible according to the invention for, for example in the case of cellulose, a solid skin to form first while the interior of the portion is still soft and effectively liquid when the portion is separated off from the surface of the perforated plate. Solidification proceeds in parallel to the further transport of the spherical particles formed. If the solidification rate is fast, it is possible for the portions to solidify before an ideal spherical shape has been formed. Lens-shaped or ellipsoidal bodies or even flat ellipsoidal disks are then obtained.

In a preferred embodiment of the process of the invention, at least the steps (B) and (C) of the process of the invention are carried out continuously, so that portions of the solution or dispersion from step (A) are produced continually in step (B) and these are introduced into step (C) of the process of the invention. In a further preferred embodiment, step (A) is also carried out continuously.

In a particularly preferred embodiment of the process of the invention, the portions produced in step (B) are transferred directly to step (C) by, for example, using the apparatus for underwater pelletization in which water into which the portions produced in step (B) are introduced preferably flows. As a result, solvents or dispersion media from step (A) are preferably replaced by water while flowing into water, so that the discrete particies are transported away by the flowing water and solidify in the process.

After the solvent exchange as per step (C) is complete, solid spherical particles which, since they still comprise a medium which is miscible with the solvent or dispersion medium from step (A), are swollen are obtained. These can, according to the invention, be processed further in this form, i.e. in the moist state.

In a further preferred embodiment of the process of the invention, step (C) is followed by step (D):

### Step (D):

Step (D) of the process of the invention comprises isolation and drying of the spherical particles obtained in step (C).

The isolation of the spherical particles obtained in step (C) can be carried out by all methods known to those skilled in the art, for example filtration, decantation, centrifugation or removal of the solvent from step (C) under reduced pressure and/or at elevated temperature. The spherical particles obtained in step (C) are preferably separated off from the liquid phase by filtration. The isolation step gives solid spherical particles which are swollen because of the presence of the medium used in step (C). The content of, preferably, water is generally from 1000 to 20% by weight, preferably from 800 to 50% by weight, in each case based on the mass of solids in the particle.

Drying of the swollen, spherical particles can be carried out by all methods known to those skilled in the art, for example, at a temperature of from 20 to 120° C., preferably from 40 to 100° C. In addition, the pressure can be decreased to a pressure below atmospheric pressure, for example <900 mbar, preferably <800 mbar.

The spherical particles which can be produced by the process of the invention have a relatively high uniformity of the particle sizes obtained.

The present patent application therefore also relates to spherical particles which can be produced by the process of the invention. These spherical particles, which comprise at least one material selected from the group consisting of natural polymers, synthetic polymers and mixtures thereof, generally have a diameter of from 0.1 to 5 mm, preferably from 0.5 to 2 mm. Furthermore, they have a high uniformity of the particles in terms of size and shape.

The present invention further relates to a spherical particle comprising at least one material selected from the group consisting of natural polymers, synthetic polymers and mixtures thereof, wherein the particle has a diameter of from 0.1 to 5 mm.

### FIGURE

FIG. 1 shows cellulose beads produced according to the invention from 1-ethyl-3-methylimidazolium acetate solution, still moist with water.

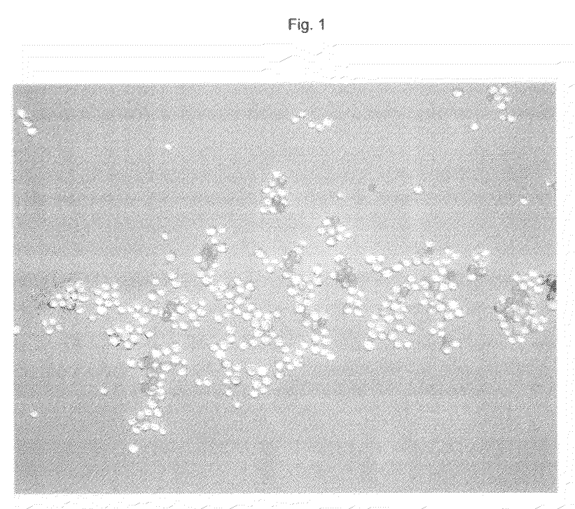

### EXAMPLES

### Example 1

A 10% strength by weight solution of cellulose from Sappi Saiccor in 1-ethyl-3-methylimidazolium acetate is placed in a reservoir heated to 80° C. of a gear pump having a capacity of up to 2.5 kg/h. This solution is pushed by means of the gear pump through a capillary line which has been heated to 80° C. and through an individually supplied hole of a perforated plate of an underwater pelletization apparatus (from Gala) provided with 8 holes of which 7 are closed by screws. On the other side of the perforated plate, in the cutting chamber of the underwater pelletization unit through which water flows, the highly viscous solution stream exiting through the hole of the perforated plate (0.8 mm) is divided into “portions” by a rotating ring of knives (5 knives, pitch: 22.5°) and these very quickly assume a spherical shape because of the surface tension. Here, the portion exiting from the hole between two passes of a knife becomes one sphere.

The spheres which have been cut off are entrained in the stream of water and collected in a receiver, with the spheres being retained by a screen or mesh and finally being removed from the stream of water.

The throughput is 1.2 kg of solution/h. The rotational speed of the knives is 1000 rpm and 5 beads are produced per revolution. The moist beads are dried at 50° C. for 48 hours. The bulk density is 0.85 g/cm³. Particle analysis indicates a proportion of >95% in the range from 1000 to 1600 μm, and of this 56% in the range from 1250 to 1600 μm and 43% in the range from 1000 to 1250 μm.

### Examples 2.1 to 2.7

The construction of the apparatus corresponds to example 1.

In an underwater pelletization unit (LPU, from Gala), a hole of an 8*0.8 mm perforated plate is supplied through a capillary with a cellulose solution (10, 15 or 20% by weight of cellulose in 1-ethyl-3-methylimidazolium acetate) by means of a gear pump. The temperature of the solution, the line and the reservoir is 90° C. The temperature of the perforated plate is 120° C. The pressure upstream of the perforated plate is 8, 10 or 11 bar. The throughput is 1.2 kg of solution/h. The results are shown in table 1.

| | | | Concentration | Pressure up- |
|---|---|---|---|---|
| | Rotational speed of | Sphere | of the cellulose | stream of the |
| | knives [revolutions | diameter | solution [% | perforated plate |
| No. | per minute, rpm] | [mm] | by weight] | [bar] |
| 2.1 | 1000 | 1.8-1.9 | 10 | 8 |
| 2.2 | 1500 | 1.4-1.5 | 10 | 8 |
| 2.3 | 2000 | 1.1-1.2 | 10 | 8 |
| 2.4 | 3000 | 1.0-1.1 | 10 | 8 |
| 2.5 | 3500 | 0.9-1.0 | 10 | 8 |
| 2.6 | 2000 | 1.2 | 15 | 10 |
| 2.7 | 2000 | 1.4 | 20 | 11 |

### Example 3

An underwater pelletization unit (LPU, from GALA) having an 8*0.8 mm perforated plate in which each second hold is closed is supplied by means of a gear pump with a solution of 8% by weight of cellulose in 1-ethyl-3-methylimidazolium acetate from a reservoir heated to 90° C. The total throughput is 4.8 kg/h. The perforated plate is heated to 120° C., and the pressure drop through the perforated plate is from 6 to 7 bar. The rotational speed of the knives is 2000 rpm. The bead size, measured by means of a sliding caliber having an electronic readout, is 1.28±0.1 mm in the moist state, measured on 10 specimens. The process proceeds uniformly for 6 hours. A total of 20 kg of moist beads are produced in this way.

### Example 4

### Polysulfone in N-methylpyrrolidone (NMP)

The apparatus described in examples 1 and 2 is employed. A 20% strength by weight solution of polysulfone in NMP is used. The throughput is 1.25 kg/h, the rotational speed of the knives is 1200 rpm and the pressure upstream of the perforated plate is 28 bar. Uniformly defined beads having a diameter of about 2 mm are formed.

1. A process for producing at least one spherical particle of at least one material, which comprises:
(A) preparing a solution or dispersion of the at least one material in al least one water-miscible solvent or dispersion medium,
(B) converting the solution or dispersion obtained in (A) into at least one individual portion comprising an amount of the at least one material corresponding to the amount present in the at least one spherical particle by underwater pelletization and (C) introducing the at least one individual portion obtained in (B) into a medium which is miscible with the water-miscible solvent or dispersion medium from (A) and in which the material in (A) is insoluble so that the solvent or dispersion medium in (A) is replaced by the medium which is miscible with the water-miscible solvent or dispersion medium from (A) and the material solidifies to form the at least one spherical particle.

2. The process according to claim 1, wherein the at least one material is at least one selected from the group consisting of a natural polymer and a synthetic polymer.

3. The process according to claim 1, wherein the at least one water-miscible solvent or dispersion medium is at least one selected from the group consisting of a cyclic ether, a cyclic amide, a sulfur-comprising organic solvent, an alcohol, a ketone, and an ionic liquid.

4. The process according to claim 1, wherein the at least one material is cellulose and the at least one water-miscible solvent or dispersion medium is an ionic liquid.

5. The process according to claim 1, wherein the underwater pelletization is carried out by pushing the solution or dispersion obtained in (A) through a die plate, comprising at least a front side and an opposite side, and dividing the exiting solution or dispersion into at least one portion on the opposite side of the die plate.

6. The process according to claim 5, wherein the dividing is carried out by a knife which slides across the die plate.

7. The process according to claim 5, wherein the solution or dispersion obtained in (A) is pushed through the die plate under a pressure of from 1 to 60 bar.

8. The process according to claim 1, wherein the medium which is miscible with the water-miscible solvent or dispersion medium from (A) is water.

9. The process according to claim 1, wherein (C) is followed by (D):
(D) isolating and drying of the at least one spherical particle obtained in (C).

10. A spherical particle produced by a process according to claim 1, comprising at least one natural polymer, wherein the particle has a diameter of from 0.1 to 5 mm.
